(19) United States
(12) Patent Application Publication
(10) Pub. No.: US 2020/0279517 A1
(43) Pub. Date: Sep. 3, 2020

(54) ORGANIC LIGHT EMITTING DIODE DISPLAY PIXEL ARRAY

(71) Applicant: WUHAN CHINA STAR OPTOELECTRONICS SEMICONDUCTOR DISPLAY TECHNOLOGY CO., LTD., Wuhan,Hubei (CN)

(72) Inventor: Jinchang HUANG, Wuhan (CN)

(73) Assignees: WUHAN CHINA STAR OPTOELECTRONICS SEMICONDUCTOR DISPLAY TECHNOLOGY CO., LTD., Wuhan, Hubei (CN); WUHAN CHINA STAR OPTOELECTRONICS SEMICONDUCTOR DISPLAY TECHNOLOGY CO., LTD., Wuhan, Hubei (CN)

(21) Appl. No.: 16/476,045

(22) PCT Filed: Apr. 15, 2019
(86) PCT No.: PCT/CN2019/082669

§ 371 Date: Jul. 3, 2019

(30) Foreign Application Priority Data
Jan. 30, 2019 (CN) 201910094066.4

(51) Int. Cl. G09G 3/20; G09G 3/3208

(52) U.S. Cl. CPC G09G 3/2003; G09G 2300/0452; G09G 2300/0443; G09G 3/3208

(57) ABSTRACT

An organic light emitting diode (OLED) display pixel array includes a plurality of pixel units, wherein each of the pixel units comprises at least three sub-pixels of different colors, and each of the pixel units comprises at least two sub-pixels of a same color. The present application provides the OLED display pixel array in which brightness correction is performed by adding additional sub-pixels, which increases the display gamut width and brightness uniformity of the OLED display.

### BACKGROUND OF INVENTION

### Field of Invention

The present invention relates to the field of display technologies, and in particular, to an organic light emitting diode (OLED) display pixel array.

### Description of Prior Art

Organic light emitting diode (OLED) devices have advantages of light weight, high contrast, wide color gamut, etc., and can be prepared on a flexible substrate, which is considered to be one of display technologies having application prospects in various display devices in the future.

At present, although luminous efficiency inside the OLED device is close to 100%, a proportion of light that can be successfully extracted outside the OLED needs to be improved. When the light generated by the OLED device propagates inside the OLED device, reflection, refraction, and total reflection occur due to different optical coefficients (such as a refractive index) at an interface of each material. To obtain high-efficiency OLED devices, light extraction efficiency must be improved, and how to improve the color gamut performance of display devices should be a focus in research and development.

### Technical Problems

In summary, in the existing OLED pixel array, there are still problems, such as uniform brightness and gamut breadth, to be improved, and there is an urgent need for improvement.

### SUMMARY OF INVENTION

The present application provides an organic light emitting diode (OLED) display pixel array to solve the problems that the brightness of the existing OLED pixel array is uniform, and the gamut breadth of the existing OLED pixel array needs to be improved

To solved the above problems, the present application provides an organic light emitting diode (OLED) display pixel array comprising a plurality of pixel units, wherein each of the pixel units comprises at least three sub-pixels of different colors, and each of the pixel units comprises at least two sub-pixels of same color, displaying of the sub-pixels is controlled by an array control circuit.

According to a preferred embodiment provided by the present application, each of the pixel units consists of one red sub-pixel, one green sub-pixel, and two blue sub-pixels, or consists of a red sub-pixel, a blue sub-pixel, and two green sub-pixels, or consists of a blue sub-pixel, a green sub-pixel, and two red sub-pixels.

According to a preferred embodiment provided by the present application, when each of the pixel units consists of one red sub-pixel, one green sub-pixel, and two blue sub-pixels, Y-axis coordinates of the two blue sub-pixels in a chromaticity coordinate 1931 system range from 0.03 to 0.06.

According to a preferred embodiment provided by the present application, when each of the pixel units consists of one blue sub-pixel, one green sub-pixel, and two red sub-pixels, X-axis coordinates of the two red sub-pixels in a chromaticity coordinate 1931 system range from 0.650 to 0.695.

According to a preferred embodiment provided by the present application, when each of the pixel units consists of one red sub-pixel, one blue sub-pixel, and two green sub-pixels, X-axis coordinate of the two green sub-pixels in a chromaticity coordinate 1931 system range from 0.22 to 0.27.

According to a preferred embodiment provided by the present application, n each of the pixel units consists of two blue sub-pixels, two red sub-pixels, and two green sub-pixels.

According to a preferred embodiment provided by the present application, Y-axis coordinates of the two blue sub-pixels in a chromaticity coordinate 1931 system range from 0.03 to 0.06; X-axis coordinates of the two red sub-pixels in a chromaticity coordinate 1931 system range from 0.650 to 0.695; X-axis coordinates of the two green sub-pixels in a chromaticity coordinate 1931 system range from 0.22 to 0.27.

According to a preferred embodiment provided by the present application, each of the red sub-pixels, each of the blue sub-pixels, and each of the green sub-pixels are connected to an array control circuit.

According to a preferred embodiment provided by the present application, each of the sub-pixels has a shape of a diamond shape, a rectangular shape, an elliptical shape, a square shape or a circular shape.

According to a preferred embodiment provided by the present application, the shapes of the sub-pixels of different colors are the same or different.

The present application further provides an organic light emitting diode (OLED) display pixel array comprising a plurality of pixel units, wherein each of the pixel units comprises at least three sub-pixels of different colors, and each of the pixel units comprises at least two sub-pixels of same color.

According to a preferred embodiment provided by the present application, each of the pixel units consists of one red sub-pixel, one green sub-pixel, and two blue sub-pixels, or consists of a red sub-pixel, a blue sub-pixel, and two green sub-pixels, or consists of a blue sub-pixel, a green sub-pixel, and two red sub-pixels.

According to a preferred embodiment provided by the present application, when each of the pixel units consists of one red sub-pixel, one green sub-pixel, and two blue sub-pixels, a Y-axis coordinates of the two blue sub-pixels in a chromaticity coordinate 1931 system range from 0.03 to 0.06.

According to a preferred embodiment provided by the present application, n when each of the pixel units consists of one blue sub-pixel, one green sub-pixel, and two red sub-pixels, X-axis coordinatess of the two red sub-pixels in a chromaticity coordinate 1931 system range from 0.650 to 0.695.

According to a preferred embodiment provided by the present application, when each of the pixel units consists of one red sub-pixel, one blue sub-pixel, and two green sub-pixels, X-axis coordinates of the two green sub-pixels in a chromaticity coordinate 1931 system range from 0.22 to 0.27.

According to a preferred embodiment provided by the present application, each of the pixel units consists of two blue sub-pixels, two red sub-pixels, and two green sub-pixels.

According to a preferred embodiment provided by the present application, Y-axis coordinates of the two blue sub-pixels in a chromaticity coordinate 1931 system range from 0.03 to 0.06, X-axis coordinates of the two red sub-pixels in a chromaticity coordinate 1931 system range from 0.650 to 0.695, X-axis coordinates of the two green sub-pixels in a chromaticity coordinate 1931 system range from 0.22 to 0.27.

According to a preferred embodiment provided by the present application, each of the red sub-pixels, each of the blue sub-pixels, and each of the green sub-pixels are connected to an array control circuit.

According to a preferred embodiment provided by the present application, n each of the sub-pixels has a shape of one of a diamond shape, a rectangular shape, an elliptical shape, a square shape, or a circular shape.

According to a preferred embodiment provided by the present application, the shapes of the sub-pixels of different colors are the same or different.

### Beneficial Effects

Compared with the prior art, the present application provides an organic light emitting diode (OLED) display pixel array in which brightness correction is performed by adding additional sub-pixels, which increases the display gamut breadth and brightness uniformity of the OLED display.

### BRIEF DESCRIPTION OF DRAWINGS

In order to describe clearly the embodiment in the present disclosure or the prior art, the following will introduce the drawings for the embodiment shortly. Obviously, the following description is only a few embodiments, for the common technical personnel in the field it is easy to acquire some other drawings without creative work.

FIG. 1 is a structural diagram of a first structure of a pixel array of an organic light emitting diode (OLED) display according to an embodiment of the present application.

FIG. 2 is a structural diagram of a second structure of a pixel array of an OLED display according to an embodiment of the present application.

FIG. 3 is a structural diagram of a third structure of a sub-pixel array of an OLED display according to an embodiment of the present application.

FIG. 4 is a structural diagram of a fourth structure of a sub-pixel array of an OLED display according to an embodiment of the present application.

### DETAILED DESCRIPTION OF PREFERRED EMBODIMENTS

The technical solutions in the embodiments of the present application will be clearly and completely described in the following with reference to the accompanying drawings in the embodiments. It is apparent that the described embodiments are only a part of the embodiments of the present application, and not all of them. All other embodiments obtained by a person skilled in the art based on the embodiments of the present application without creative efforts are within the scope of the present application.

In the description of the present application, it is to be understood that the orientation or positional relationship indicated by the terms such as “center”, “longitudinal”, “transverse”, “length”, “width”, “thickness”, “high”, “low”, “front”, “back”, “left”, “right”, ““vertical”, “horizontal”, “top”, “bottom”, “inside”, “outside”, “clockwise”, “counterclockwise”, etc. is based on the orientation or positional relationship shown in the drawings, and is only for convenience of description of the present application and simplified description, which is not indicating or implying that the device or component referred to must have a particular orientation, constructed and operated in a particular orientation, thus it is not to be construed as limiting the invention. Moreover, the terms “first” and “second” are used for descriptive purposes only and are not to be construed as indicating or implying a relative importance or implicitly indicating the number of technical features indicated. Thus, features defining “first” or “second” may include one or more of the described features either explicitly or implicitly. In the description of the present application, the meaning of “a plurality” is two or more unless specifically and specifically defined otherwise.

Referring to FIG. 1, a first structural diagram 10 of an organic light emitting diode (OLED) display provided by the present application is shown. 1 is a pixel unit, 11 is a first blue sub-pixel, 12 is a green sub-pixel, 13 is a red sub-pixel, and 14 is a second blue sub-pixel. A pixel array includes two green sub-pixels.

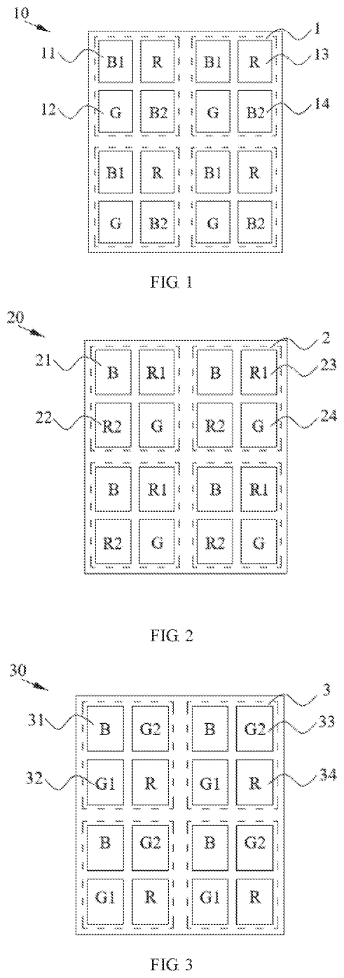

Referring to FIG. 2, a second structural diagram 20 of an OLED display provided by the present application is shown. 2 is a pixel unit, 21 is a blue sub-pixel, 22 is a second red sub-pixel, 23 is a first red sub-pixel, and 24 is a green sub-pixel. A pixel array includes two red sub-pixels.

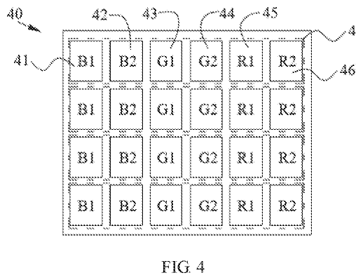

Referring to FIG. 3, a third structural diagram 30 of an OLED display provided by the present application is shown. 3 is a pixel unit, 31 is a blue sub-pixel, 32 is a first green sub-pixel, 33 is a second green sub-pixel, and 34 is a red sub-pixel. A pixel array includes two green sub-pixels.

Referring to FIG. 4, a fourth structural diagram 40 of an OLED display provided by the present application is shown. 4 is a pixel unit, 41 is a first blue sub-pixel, 42 is a second blue sub-pixel, 43 is a first green sub-pixel, 44 is a second green sub-pixel, 45 is a first red sub-pixel, and 46 is a second red sub-pixels.

### First Embodiment

The present application provides an OLED display pixel array includes a plurality of pixel units, wherein each of the pixel units includes at least three sub-pixels of different colors, and each of the pixel units comprises at least two sub-pixels of same color. In the first embodiment, each of the pixel units includes four sub-pixels of three colors of red, green, and blue, wherein the number of sub-pixels having the same color is two, and the number of sub-pixels of other colors is only one.

According to a preferred embodiment provided by the present application, each of the pixel units consists of one red sub-pixel, one green sub-pixel, and two blue sub-pixels, see FIG. 1. Each of the pixel units consists of one red sub-pixel, one blue sub-pixel, and two green sub-pixels, see FIG. 3. Each of the pixel units consists of one blue sub-pixel, one green sub-pixel, and two red sub-pixels, see FIG. 2.

According to a preferred embodiment provided by the present application, when each of the pixel units consists of one red sub-pixel, one green sub-pixel, and two blue sub-pixels, Y-axis coordinates of the two blue sub-pixels in a chromaticity coordinate 1931 system range from 0.03 to 0.06, a preferred range is from 0.04 to 0.05.

According to a preferred embodiment provided by the present application, when each of the pixel units consists of one blue sub-pixel, one green sub-pixel, and two red sub-pixels, X-axis coordinates of the two red sub-pixels in a chromaticity coordinate 1931 system range from 0.650 to 0.695, a preferred range is from 0.660 to 0.685.

According to a preferred embodiment provided by the present application, when each of the pixel units consists of one red sub-pixel, one blue sub-pixel, and two green sub-pixels, X-axis coordinates of the two green sub-pixels in a chromaticity coordinate 1931 system range from 0.22 to 0.27, a preferred range is from 0.23 to 0.26.

According to a preferred embodiment provided by the present application, each of the red sub-pixel, the blue sub-pixel, and the green sub-pixel is connected to an array control circuit. When the OLED display is in full operation or in part operation, it is controlled by the array control circuit to solve the closed state of each sub-pixel.

According to a preferred embodiment provided by the present application, each of the sub-pixels has a shape of a diamond shape, a rectangular shape, an elliptical shape, a square shape or a circular shape. The shapes of the sub-pixels of different colors are the same or different.

### Second Embodiment

The present application provides an OLED display pixel array including a plurality of pixel units, wherein each of the pixel units includes at least three sub-pixels of different colors, and each of the pixel units comprises at least two sub-pixels of same color. In the second embodiment, each of the pixel units consists of two blue sub-pixels, two red sub-pixels, and two green sub-pixels.

According to a preferred embodiment provided by the present application, each of the pixel units is composed of two blue sub-pixels, two red sub-pixels, and two green sub-pixels.

According to a preferred embodiment provided by the present application, Y-axis coordinates of the two blue sub-pixels in a chromaticity coordinate 1931 system range from 0.03 to 0.06; X-axis coordinates of the two red sub-pixels in a chromaticity coordinate 1931 system range from 0.650 to 0.695; X-axis coordinates of the two green sub-pixels in a chromaticity coordinate 1931 system range from 0.22 to 0.27.

According to a preferred embodiment provided by the present application, each of the red sub-pixels, each of the blue sub-pixels, and each of the green sub-pixels are connected to an array control circuit. When the OLED display is in full operation or in part operation, it is controlled by the array control circuit to solve the closed state of each sub-pixel.

According to a preferred embodiment provided by the present application, each of the sub-pixels has a shape of a diamond shape, a rectangular shape, an elliptical shape, a square shape or a circular shape. The shapes of the sub-pixels of different colors are the same or different.

As is understood by persons skilled in the art, the foregoing preferred embodiments of the present disclosure are illustrative rather than limiting of the present disclosure. It is intended that they cover various modifications and that similar arrangements be included in the spirit and scope of the present disclosure, the scope of which should be accorded the broadest interpretation so as to encompass all such modifications and similar structures.

What is claimed is:

1. An organic light emitting diode (OLED) display pixel array comprising a plurality of pixel units, wherein each of the pixel units comprises at least three sub-pixels of different colors, and each of the pixel units comprises at least two sub-pixels of a same color, displaying of the sub-pixels is controlled by an array control circuit.

2. The OLED display pixel array according to claim 1, wherein each of the pixel units consists of one red sub-pixel, one green sub-pixel, and two blue sub-pixels, or consists of a red sub-pixel, a blue sub-pixel, and two green sub-pixels, or consists of a blue sub-pixel, a green sub-pixel, and two red sub-pixels.

3. The OLED display pixel array according to claim 2, wherein when each of the pixel units consists of one red sub-pixel, one green sub-pixel, and two blue sub-pixels, Y-axis coordinates of the two blue sub-pixels in a chromaticity coordinate 1931 system range from 0.03 to 0.06.

4. The OLED display pixel array according to claim 2, wherein when each of the pixel units consists of one blue sub-pixel, one green sub-pixel, and two red sub-pixels, X-axis coordinates of the two red sub-pixels in a chromaticity coordinate 1931 system range from 0.650 to 0.695.

5. The OLED display pixel array according to claim 2, wherein when each of the pixel units consists of one red sub-pixel, one blue sub-pixel, and two green sub-pixels, X-axis coordinates of the two green sub-pixels in a chromaticity coordinate 1931 system range from 0.22 to 0.27.

6. The OLED display pixel array according to claim 1, wherein each of the pixel units consists of two blue sub-pixels, two red sub-pixels, and two green sub-pixels.

7. The OLED display pixel array according to claim 6, wherein Y-axis coordinates of the two blue sub-pixels in a chromaticity coordinate 1931 system range from 0.03 to 0.06; X-axis coordinates of the two red sub-pixels in a chromaticity coordinate 1931 system range from 0.650 to 0.695; X-axis coordinates of the two green sub-pixels in a chromaticity coordinate 1931 system range from 0.22 to 0.27.

8. The OLED display pixel array according to claim 6, wherein each of the red sub-pixels, each of the blue sub-pixels, and each of the green sub-pixels are connected to an array control circuit.

9. The OLED display pixel array according to claim 8, wherein each of the sub-pixels has a shape of a diamond shape, a rectangular shape, an elliptical shape, a square shape or a circular shape.

10. The OLED display pixel array according to claim 9, wherein the shapes of the sub-pixels of different colors are the same or different.

11. An organic light emitting diode (OLED) display pixel array comprising a plurality of pixel units, wherein each of the pixel units comprises at least three sub-pixels of different colors, and each of the pixel units comprises at least two sub-pixels of a same color.

12. The OLED display pixel array according to claim 11, wherein each of the pixel units consists of one red sub-pixel, one green sub-pixel, and two blue sub-pixels, or consists of a red sub-pixel, a blue sub-pixel, and two green sub-pixels, or consists of a blue sub-pixel, a green sub-pixel, and two red sub-pixels.

13. The OLED display pixel array according to claim 12, wherein when each of the pixel units consists of one red sub-pixel, one green sub-pixel, and two blue sub-pixels, Y-axis coordinates of the two blue sub-pixels in a chromaticity coordinate 1931 system range from 0.03 to 0.06.

14. The OLED display pixel array according to claim 12, wherein when each of the pixel units consists of one blue sub-pixel, one green sub-pixel, and two red sub-pixels, X-axis coordinates of the two red sub-pixels in a chromaticity coordinate 1931 system range from 0.650 to 0.695.

15. The OLED display pixel array according to claim 12, wherein when each of the pixel units consists of one red sub-pixel, one blue sub-pixel, and two green sub-pixels, X-axis coordinates of the two green sub-pixels in a chromaticity coordinate 1931 system range from 0.22 to 0.27.

16. The OLED display pixel array according to claim 11, wherein each of the pixel units consists of two blue sub-pixels, two red sub-pixels, and two green sub-pixels.

17. The OLED display pixel array according to claim 16, wherein Y-axis coordinates of the two blue sub-pixels in a chromaticity coordinate 1931 system range from 0.03 to 0.06, X-axis coordinates of the two red sub-pixels in a chromaticity coordinate 1931 system range from 0.650 to 0.695, X-axis coordinates of the two green sub-pixels in a chromaticity coordinate 1931 system range from 0.22 to 0.27.

18. The OLED display pixel array according to claim 16, wherein each of the red sub-pixels, each of the blue sub-pixels, and each of the green sub-pixels are connected to an array control circuit.

19. The OLED display pixel array according to claim 18, wherein each of the sub-pixels has a shape of one of a diamond shape, a rectangular shape, an elliptical shape, a square shape, or a circular shape.

20. The OLED display pixel array according to claim 19, wherein the shapes of the sub-pixels of different colors are the same or different.
